(19) United States
(12) Patent Application Publication
(10) Pub. No.: US 2017/0316465 A1
(43) Pub. Date: Nov. 2, 2017

(54) Ad Context Visualization and Mock-Up Tool

(71) Applicant: Oracle America, Inc., Redwood Shores, CA (US)

(72) Inventors: David Titus, Mount Airy, MD (US); Nicholas Perez, New York, NY (US); Robert Crowell, New York, NY (US); Robert Miller, New York, NY (US); Noah Goodhart, New York, NY (US); Aniq Rahman, New York, NY (US)

(73) Assignee: Oracle America,Inc., Redwood Shores, CA (US)

(21) Appl. No.: 13/931,257

(22) Filed: Jun. 28, 2013

Related U.S. Application Data
(60) Provisional application No. 61/666,817, filed on Jun. 30, 2012.

(51) Int. Cl. G06Q 30/02

(52) U.S. Cl. CPC G06Q 30/0276

(57) ABSTRACT

A system and methods for creating an instant interactive visualization and providing a display of what an advertisement may appear as on any published web page. In some implementations, the system and methods provide an ad-context visualization and mock-up tool that enables a user to view mock-up representations of one or more advertisements and show prospective or current advertising clients with ease what a particular advertisement will ultimately appear as in a context specified by a user.

### CROSS REFERENCE TO RELATED APPLICATIONS

The present application claims the benefit of priority under 35 U.S.C. §119(e) of U.S. Provisional Application No. 61/666,817 entitled “Ad Context Visualization and Mock-up Tool,” filed on Jun. 30, 2012, by Jonah Goodhart, Noah Goodhart, and Robert Collier Crowell. The entire contents of the provisional application are incorporated by reference herein.

### BACKGROUND

The present invention relates to systems and methods for ad-context visualization and a mock-up tool. In particular, the present invention relates to selecting a webpage and superimposing advertisement (“ad”) content on the webpage to generate a mock-up representation of the potential webpage with the superimposed ad content facilitating viewing by users before an advertisement is served.

The Internet and other types of on-line communication have become increasingly popular in recent years to an extent where they now compete with traditional media such as print media and broadcast media for the attention of users. Because users are spending more and more time on-line, either viewing content, playing games or communicating on social networks, advertisers are spending greater amounts of their advertising dollars on Internet or online advertising to target these users. It is now commonplace for advertisers to use online advertising as a major component of any advertising campaign.

Online advertising typically refers to any type of promotion that uses the Internet or the “World Wide Web” to deliver marketing messages and attract the attention of potential customers. Examples of online advertising include contextual ads on search, engine-result pages, banner ads, rich-media ads, social-networking ads, interstitial advertising, etc. Online advertising is typically provided from an ad server to a publisher that includes the ads with the published or served content. These new forms of online advertising are advantageous because they provide better targeting and placement of ads then traditional media ever did.

### SUMMARY

A system and methods for creating an instant interactive visualization of what any advertisement (i.e., ad) would look like on any published web page. In some implementations, the system provides an ad-context visualization and mock-up tool that enables a user to show prospective or current advertising clients with ease what an advertisement would look like in any context in which it could possibly appear or as specified by a user.

In some implementations, a method for visualizing advertisement content may include operations for receiving one or more web addresses from users; receiving one or more web pages selected and corresponding to the one or more web addresses; providing a selection of one or more advertisements for users to identify one or more advertisements of interest; receiving from the one or more users indications of the one or more locations corresponding to positions on the one or more web pages; generating a mock-up representations including the one or more advertisements at the one or more locations on the one or more web pages; providing the mock-up representation for display; and, in some instances, storing the mock-up representation for subsequent use.

In some implementations, a system for visualizing advertisement content an mock-up tool may include a processor and a memory storing instructions that, when executed, cause the system to receive one or more web addresses from users; receive one or more web pages selected and corresponding to the one or more web addresses; provide a selection of one or more advertisements for users to identify one or more advertisements of interest; receive from the one or more users indications of the one or more locations corresponding to positions on the one or more web pages; generate a mock-up representation including the one or more advertisements at the one or more locations on the one or more web pages; provide the mock-up representation for display; and, in some instances, store the mock-up representation for subsequent use.

In some implementations, the mock-up tool may be provided as a plug-in or a standalone application program operable in one or more computing or electronic devices in a distributed architecture or otherwise. The system, methods, and mock-up tool of the present technology advantageously provides a way for users or others in the advertisement world to view a mock-up representation of what one or more advertisements may appear as before the advertisements are served.

### BRIEF DESCRIPTION OF THE DRAWINGS

The present disclosure is illustrated by way of example, and not by way of limitation, in the figures of the accompanying drawings, in which like reference numerals are used to refer to similar elements.

FIG. 1 is a block diagram of an example system that serves as an ad-context visualization and mock-up tool in accordance with the present invention.

FIG. 2A is a block diagram illustrating example hardware components in some implementations of the system shown in FIG. 1.

FIG. 2B is a block diagram illustrating an example mock-up plugin illustrated in FIG. 1 and its software components.

FIG. 3A is a flow diagram of an example process for creating an instant visualization of what any ad would look like on any published web page.

FIG. 3B is a flow diagram of an example method of storing a mock-up on a mock-up database.

FIG. 4 is a detailed flow diagram of an example process between a client browser and a server for creating an instant visualization of what any ad would look like on any published web page.

FIG. 5 is a graphic representation of an example user interface for specifying a webpage and ad content to superimpose on the specified webpage.

FIG. 6 is a graphic representation of an example user interface for displaying a webpage.

FIG. 7 is a graphic representation of an example user interface for adding ad content to a specified webpage.

FIG. 8 is a graphic representation of an example user interface for specifying a location for ad content.

FIG. 9 is a graphic representation of an example user interface for saving a mock-up of ad content and a specified webpage.

### DETAILED DESCRIPTION

In some implementations and applications, a publisher may desire to show possible advertising clients that their advertisement (i.e., ad) would be effective on the publisher's website. In these instances, the publisher may access the system and use the mock-up tool provided by the system to show the client what the ad would look like in a particular location on the publisher's website. In other implementations, the system may be configured to provide access from within another information system, and used to help publishers organize their own websites by testing visual compatibility between an ad and its context.

In the following description, for purposes of explanation, numerous specific details are indicated in order to provide a thorough understanding of the technology described. It should be apparent, however, to one skilled in the art, that this technology can be practiced without these specific details. In other instances, structures and devices are shown in block diagram form in order to avoid obscuring the technology. For example, the present technology is described with some embodiments below with reference to user interfaces and particular hardware. However, the present technology applies to any type of computing device that can receive data and commands, and any devices providing services.

Reference in the specification to “one embodiment or implementation,” “an embodiment or implementation,” or “some embodiments or implementations” means simply that one or more particular features, structures, or characteristics described in connection with the one or more embodiments or implementations is included in at least one or more embodiments or implementations that are described. The appearances of the phrase “in one embodiment or implementation” in various places in the specification are not necessarily all referring to the same embodiment or implementation.

Some portions of the detailed descriptions that follow are presented in terms of method algorithms and symbolic representations of operations on data bits within a computer memory of either one or more computing devices typically used in the systems described. These algorithmic descriptions and representations are the means used by those skilled in the data processing arts to most effectively convey the substance of their work to others skilled in the art. An algorithm as indicated here, and generally, is conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the following discussion, it should be appreciated that throughout the description, discussions utilizing terms such as “processing,” “computing,” “calculating,” “determining,” “transmitting,” or “displaying” or the like, refer to the actions and processes of a computer device or system or similar electronic computing device that manipulates and transforms data represented as physical (electronic) quantities within the computer device or system's registers and memories into other data similarly represented as physical quantities within the computer system memories or registers or other such information storage, transmission, or display devices.

The present technology also relates to system architecture for performing the operations described here. This system architecture may be specially constructed for the required purposes or methods stated here, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

This technology may take the form of an entirely hardware embodiment, an entirely software embodiment, or an embodiment including both hardware and software components. In some embodiments, this technology is implemented in software, which includes but is not limited to firmware, resident software, microcode, etc.

Furthermore, at least portions of this technology may take the form of one or more computer program products accessible from a computer-usable or computer-readable medium providing program code for use by or in connection with a computer or any instruction execution system. For the purposes of this description, a computer-usable or computer-readable medium may be any apparatus that can include, store, communicate, propagate, or transport the program for use by or in connection with the instruction execution system, apparatus, or device. The components used in systems and networks may use a data processing system suitable for storing and/or executing program code including at least one processor coupled directly or indirectly to memory elements through a system bus. The memory elements may include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) may be coupled to the system architecture either directly or through intervening I/O controllers.

Communication units including network adapters may also be coupled to the systems to enable them to couple to other data processing systems or storage devices, through either intervening private or public networks. Modems, cable modems, and Ethernet cards are just a few examples of the currently available types of network adapters.

Finally, the algorithms and operations presented in this application are not inherently related to any particular computer or other apparatus. Various general-purpose systems may be used or modified with programs in accordance with the teachings here, or it may prove convenient to construct more specialized apparatus to perform the required method steps. The required structure for a variety of these systems is outlined in the description below. In addition, the present technology is not described with reference to any particular programming language. It should be understood that a variety of programming languages may be used to implement the technology as described here.

The present technology is now described more fully with reference to the accompanying figures, in which several embodiments of the technology are shown. The present technology may be embodied or implemented in many different forms and should not be construed as limited to the embodiments or implementations set forth herein. Rather, these embodiments are provided so that this disclosure will be thorough and complete and will fully convey the invention to those skilled in the art.

One skilled in the art will recognize that methods, apparatus, systems, data structures, and computer readable media implement the features, functionalities, or modes of usage described herein. For instance, an apparatus embodiment or implementation can perform the corresponding steps or acts of a method embodiment or implementation.

### System Overview

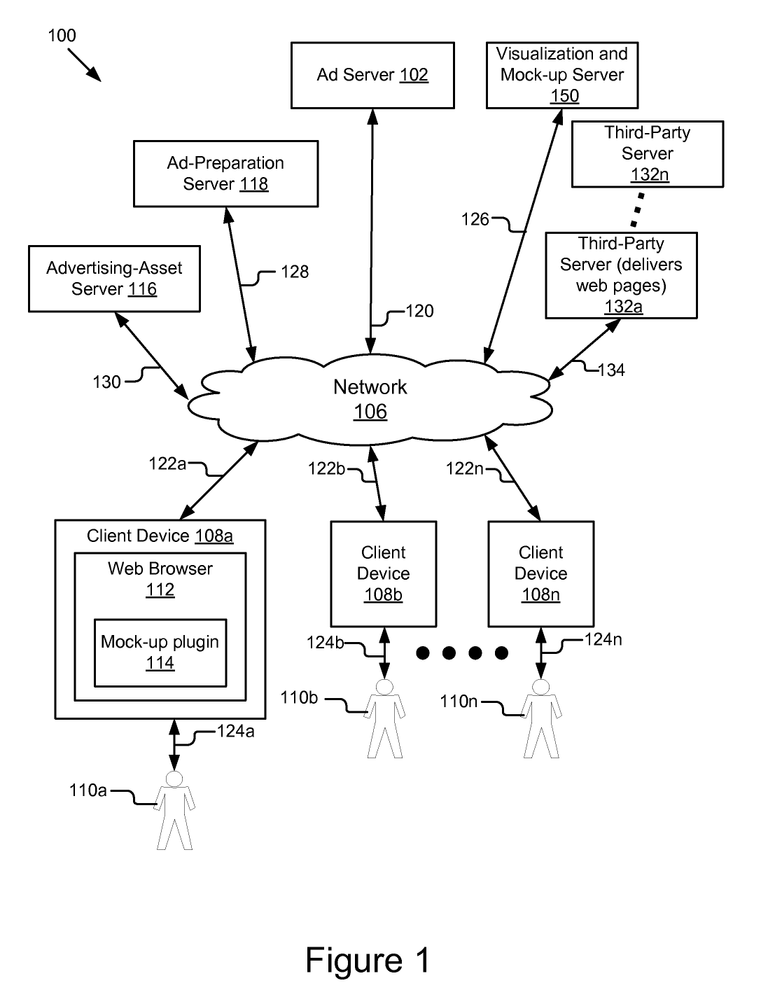

FIG. 1 illustrates a block diagram of one embodiment or implementation of the advertising system 100 of the present invention. The advertising system 100 advantageously receives, collects, and/or presents advertising analytics for on line placement of advertisements. The advertising system 100 is configured to retrieve and present on-line advertisements as described here. For many examples described in the specification below, an online advertisement (“ad”) is any text, picture, or video whose primary or other purpose is advertising communication, including any flash asset, any image of Internet Advertising Board (IAB) or industry standard width and height that is clickable including any recursion into iframes from the original page. The illustrated ad system 100 includes an advertising-asset server 116, an ad-preparation server 118, an ad server 102, a visualization- and-mock-up server 150, a network 106, one or more third-party servers 132, and one or more client devices 108a-108n that may be used or otherwise accessed by users indicated by reference numerals 110a-110n. In the illustrated embodiment or implementation, these entities are communicatively coupled via a network 106. Although only three client devices 108a-n are illustrated, it should be recognized that any number of client devices 108n are available to any number of users 110n. Furthermore, while only one network 106 is illustrated to be coupled to the advertising-asset server 116, the ad-preparation server 118, the ad server 102, the visualization-and-mock-up server 150, the third-party server 132, and the one or more client devices 108a-108n, in practice, any number of networks 106 may be connected to these entities. In one embodiment or implementation, the advertising-asset server 116, the ad-preparation server 118, the ad server 102, the visualization-and-mock-up server 150, and the third-party server 132 are hardware servers including a processor, memory, and network communication capabilities. Although only three third-party servers 132 are shown, the system 100 may include one or more third-party servers 132.

The network 106 is a conventional type, wired or wireless, and may have any number of configurations such as a star configuration, token ring configuration or other configurations. Furthermore, the network 106 may comprise a local area network (LAN), a wide area network (WAN) (e.g., the Internet), and/or any other interconnected data path across which multiple devices may communicate. In yet another embodiment, the network 106 may be a peer-to-peer network. The network 106 may also be coupled to or includes portions of a telecommunications network for sending data in a variety of different communication protocols. In yet another embodiment, the network 106 includes Bluetooth communication networks or a cellular communications network for sending and receiving data such as via short messaging service (SMS), multimedia messaging service (MMS), hypertext transfer protocol (HTTP), direct data connection, WAP, email, etc.

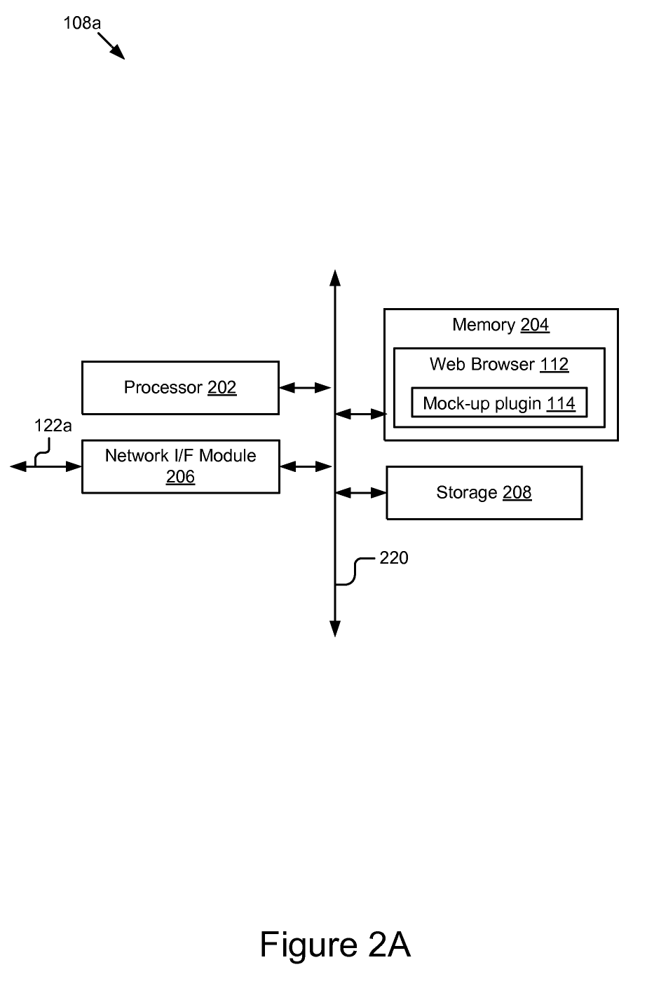

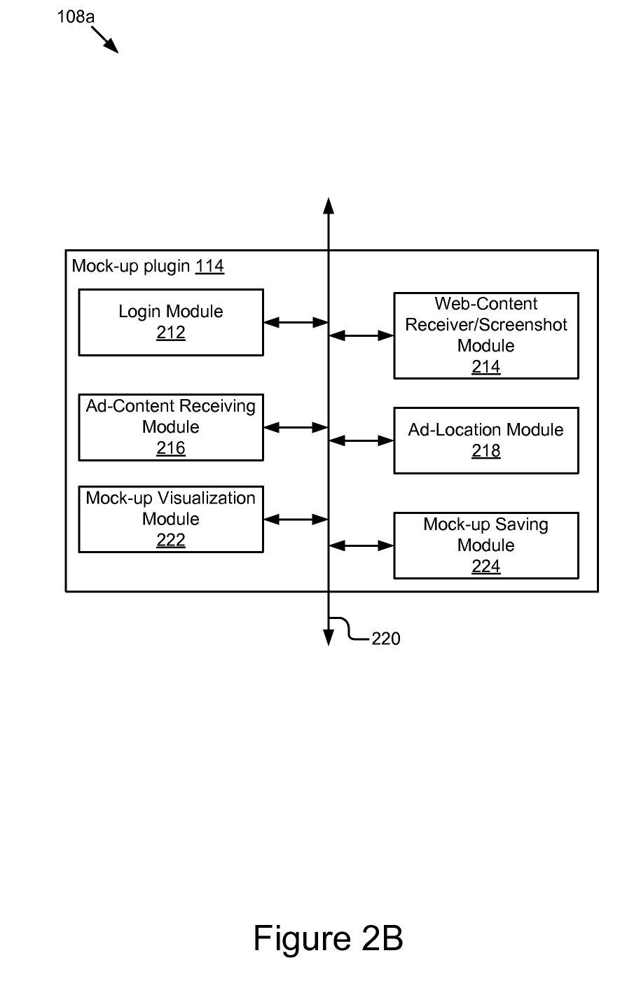

The client device 108a is representative of client devices 108a-108n and is a conventional type of computing device, for example, a personal computer, a hardware server, a laptop computer, a tablet computer or smart phone. The client devices 108a-108n may be coupled to the network 106 by signal lines 122a-122n, respectively. In one embodiment, the client device 108 may be coupled to receive online advertisements from the ad server 102 and other content from publishing sites or third-party servers. The client device 108 includes a web browser 112 for presenting online content and advertisements for display to the user and a mock-up plugin. The web browser 112 presents ads and other content, and receives input from the user 110 (a-n) as represented by a signal line 124 (a-n). The web browser 112 and mock-up plugin 114 may be configured to be operable on the client device 108. The mock-up plugin 114 may be configured to collect information about a user-specified web page by specifying the web name, address, URL (uniform resource locator), etc. The operation of the mock-up plugin 114 is described in more detail below with reference to FIGS. 2B through 9. The mock-up plugin 114 advantageously receives a web page and generates a screenshot (i.e., image) of the webpage. In one embodiment, the mock-up plugin 114 may be a program, code or software that is configured to: 1) receive a user-specified webpage; 2) receive a user-specified advertisement; 3) receive a location to superimpose the advertisement over the webpage screenshot; 4) generate a mock-up of the webpage screenshot and the superimposed advertisement; and 5) store the mock-up to a visualization and mock-up server 150.

The advertising-asset server 116 may be a computer program running on a hardware system configured to store and providing advertisements or assets to other systems that that are configured to ultimately deliver the ads to an end user. The advertising-asset server 116 is coupled to the network 106 by signal line 130 to receive advertisements or assets from advertisers. In one embodiment or implementation, the advertising-asset server 116 stores the advertisement or asset that is delivered to the client devices 108. For example, the asset may include an ad copy, ad content, a JavaScript or flash that when executed by the client device 108 in the web browser 112 presents the advertisement to the user 110 as designed by and intended by the advertisers. The advertisers interact with the advertising-asset server 116 to upload and store advertisements on the advertising-asset server 116. These advertisements are then available for delivery to the ad-preparation server 118 or the ad server 102, which in turn processes the advertisements and delivers them to the client device 108.

The ad-preparation server 118 may be a computer program operating on a hardware system for preparing advertisements for ultimate delivery to the client devices 108 (a-n). In one embodiment, the ad-preparation server 118 is configured to retrieve advertisements from the advertising asset server 116 and modify them (e.g., by adding a script). The modified ads are then delivered by the ad-preparation server 118 to the ad server 102 for combination with content and delivery to the client device 108. The ad-preparation server 118 may be coupled to the network 106 by signal line 128 for communication with the advertising-asset server 116 and the ad server 102.

The ad server 102 is a computer program operating on a hardware system for placing advertisements on websites. For example, the ad server 102 may be a web server that receives advertisements from the ad-preparation server 118 or the advertising-asset server 116 and delivers them to website visitors. The ad server 102 is coupled to the network 106 by signal line 120 for receiving ads from the ad-preparation server 118 or the advertising-asset server 116 and for delivering the ads to third-party servers 132, sites, or domains (not shown).

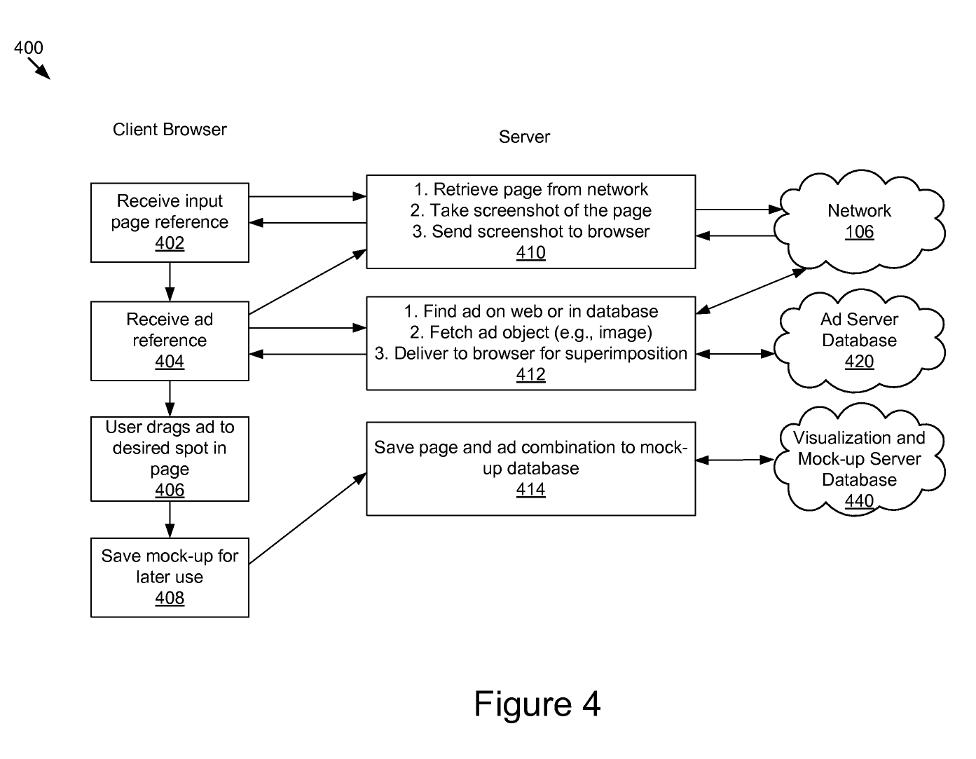

The visualization and mock-up server 150 may be a computer program operating on a hardware system for receiving, collecting, and/or retrieving and presenting visualization and mock-up information. In particular, the visualization and mock-up server 150 receives mock-up data from the mock-up plugin 114 operating on the client device 108. The visualization and mock-up server 150 may also receive visualization information (e.g., information relating to the presentation of ads) from the ad server 102. The visualization and mock-up server 150 also processes the visualization and mock-up information to produce user interfaces. The visualization and mock-up server 150 is described in more detail below with reference to FIG. 4. The visualization and mock-up server 150 is coupled by signal line 126 to the network 106 for communication with the client devices 108a-108n and the ad server 102.

### Client Device 108a

FIG. 2A is a block diagram of one embodiment or implementation of the client device 108a (similar to the other client devices 108b through 108n that are illustrated). In this embodiment or implementation, the client device 108a comprises: a processor 202, a memory 204, a network interface (I/F) module 206, storage 208, and a bus 220.

The processor 202 comprises an arithmetic logic unit, a microprocessor, a general-purpose controller or some other processor array to perform computations and provide electronic display signals to a display device. The processor 202 is coupled to the bus 220 for communication with the other components. The processor 202 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2A, multiple processors may be included. Other processors, operating systems, sensors, displays and physical configurations are possible.

The memory 204 stores instructions and/or data that may be executed by the processor 202. The memory 204 is coupled to the bus 220 for communication with the other components. The instructions and/or data may comprise code for performing any and/or all of the techniques described herein. The memory 204 may be a dynamic random access memory (DRAM) device, a static random access memory (SRAM) device, flash memory or some other memory device. In some embodiments or implementations, the memory 204 stores a web browser 112 which includes a mock-up plugin 114. In some implementations, the mock-up plugin 114 may also be separately configured.

The network interface (I/F) module 206 is coupled to network 106 by signal line 128 and coupled to the bus 220. The network interface module 206 includes ports for wired connectivity such as but not limited to USB, SD, or CAT-5, etc. The network interface (I/F) module 206 links the processor 202 to the network 106, which may in turn be coupled to other processing systems. The network interface (I/F) module 206 provides other connections to the network 106 using standard network protocols such as TCP/IP, HTTP, HTTPS and SMTP. In other embodiments, the network interface (I/F) module 206 includes a transceiver for sending and receiving signals using Wi-Fi, Bluetooth® or cellular communications for wireless communication. The network interface (I/F) module 206 provides a communication path for the components of the client device 108a to the network 106 and other systems.

In one embodiment, the storage 208 stores data, information and instructions used by the client device 108a. Such stored information includes information about users, publishers, ads, assets, mock-ups, and other information. The storage 208 is a non-volatile memory or similar permanent storage device and media such as a hard disk drive, a floppy disk drive, a CD-ROM device, a DVD-ROM device, a DVD-RAM device, a DVD-RW device, a flash memory device, or some other mass storage device for storing information on a more permanent basis. The data storage 208 is coupled by the bus 220 for communication with other components of the client device 108a.

Referring now to FIG. 2B, the mock-up plugin 114 will be described in greater detail. In some embodiments or implementations, the mock-up plugin 114 includes a login module 212, a web content receiver/screenshot module 214, an ad-content receiving module 216, an ad-location module 218, a mock-up visualization module 222, and a mock-up saving module 224 communicatively coupled via the bus 220.

The login module 212 may be software, code or routines for receiving and processing user login information from the client device 108. The login module 212 is coupled to receive requests from the client device 108. In some embodiments, the login module 212 receives a user name and password from the user 110 via the client device 108 (any of a through n). The login module 212 compares the user name and password against a login database (not shown) and if the user name and password match the data base, then the login module 212 permits access to the mock-up plugin 114. The login module 212 is coupled to the bus 220 for communication with the other components of the client device 108a (or b-n).

The web content receiver/screenshot module 214 may be software, code, or routines for receiving a web address from the client device 108. The web content receiver/screenshot module 214 is coupled to receive a web address (e.g., web name, address, URL, etc.) from the client device 108 (a-n) and, in some embodiments, may be coupled to send the web address to the ad-content receiving module 216. In some embodiments, the web-content receiver/screenshot module receives a web address from one or more of the servers illustrated in FIG. 1 and generates an image (i.e., screenshot) of the webpage specified by the web address including a visualization of the web content (e.g., text, images, videos, iframes, embedded flash content, etc.). The web content receiver/screenshot module 214 then sends the screenshot that is generated to the mock-up visualization module 222. The web-content receiver/screenshot module 214 is coupled to bus 220 for communication with the other components of the client device 108a.

The ad-content receiving module 216 may be software, code or routines for receiving ad content from the client device 108. In some embodiments, the ad-content receiving module 216 receives the ad content (e.g., image, video, text, embedded flash, and/or any other type of medium used for advertisements) from one or more of the servers illustrated in FIG. 1 and sends the ad content to the mock-up visualization module 222. For example, the ad content receiving module 216 may receive an image advertisement from the client device 108 (a-n) and sends the image to the mock-up visualization module 222. The ad content receiving module 216 is coupled to bus 220 for communication with the other components of the client device 108a.

The ad-location module 218 may be software, code or routines for receiving a location from the client device 108. In some embodiments, the ad-location module 218 receives a location from one or more of the servers described in FIG. 1. The ad-location module 218 may receive a location of the screenshot manually via specified (e.g., by the client device 108) coordinates (e.g., inches, centimeters, pixels, etc.). In other embodiments, the location may be specified by a “drag-and-drop” user interface where the user 110 (via a client device 108) drags the ad content to a desired location on the screenshot. The ad-location module 218 then sends this location (i.e., coordinates) to the mock-up visualization module 222. The ad-location module 218 is coupled to bus 220 for communication with the other components of the client device 108a (or b-n).

The mock-up visualization module 222 is software, code or routines for receiving web content, ad content, and an ad location. For example, the mock-up visualization module 222 receives web content (e.g., screenshot) from the web-content receiver/screenshot module 214, ad content from the ad-content receiving module 216, and an ad location from the ad-location module 218. In one embodiment, the mock-up visualization module 222 generates a user interface including the screenshot and the superimposed ad content at the specified location for display to the user 110 via the client device 108 (a-n). The mock-up visualization module 222 is coupled to bus 220 for communication with the other components of the client device 108a (b-n).

The mock-up saving module 224 is software, code or routines for saving the mock-up visualization to one or more servers for later use. In one embodiment or implementation, the mock-up saving module 224 stores the screenshot, advertisement (e.g., image), and the superimposed location of the advertisement. For example, a user may save the mock-up via the mock-up saving module 224 and recall the mock-up at a later time for further changes (e.g., change position of the advertisement, change advertisement, change webpage screenshot, etc.). In some embodiments, the mock-up saving module 224 is coupled to other systems such as the analytics server 104 to provide the saved mock-up visualization for storage on the one or more severs described in FIG. 1. The mock-up saving module 224 is coupled to bus 220 for communication with the other components of the client device 108a.

The (ad-context) visualization and mock-up tool is useful to publishers who may want to demonstrate to an advertiser, the contextual fit or appropriateness of online advertisement artwork to the publishing environment (e.g., webpage) created by the publisher. Example system architecture incorporating the (ad-context) visualization and mock-up tool is illustrated in FIG. 1. This tool is essential for publishers who may wish to persuade advertisers that their website is superior to other websites based on how it accommodates or fits ads with the publishing content. The present system allows the following:
1) A client (e.g., a user) logs in to a server-based application using a browser 114.
2) The user specifies any web page by specifying its web name, address, or location (URL).
3) The system allows the user to specify an image (e.g., advertisement). The image is then superimposed on the web page by the system, correctly scaled to fit the ad inventory under consideration.
   a) The image (e.g., advertisement) to be superimposed may be accessed by the system in several ways:
      i. From a database of private or proprietary ads.
      ii. From a reference to an ad on an ad server.
      iii. By specifying an image file.
4) The user can superimpose the ad over any position or location in the specified web page, creating a visualization of what that page would look like or appear as with the ad in the specified position.
5) The user can save that mock-up for later use.

The process (explained in greater detail in FIG. 4) includes at least the following operations:
1) The user may log in to the server application that presents the visualization and mock-up tool in the browser.
2) The tool allows the user to input the URL.
3) The web page corresponding to the URL is retrieved, and an image of webpage is generated by the server (e.g., a server generates a screenshot).
4) The screenshot (e.g., image) is presented to the user for viewing, in other words, the screenshot is superimposed on the tool web page for viewing by the user.
5) The user specifies the ad to be superimposed over the top of the screenshot.
6) The system accesses the ad, and places it randomly over the top of the screenshot.
7) The user can input commands and controls to drag the ad over the desired location over the screenshot.
8) The system optionally saves that particular combination of web page and ad for use later.

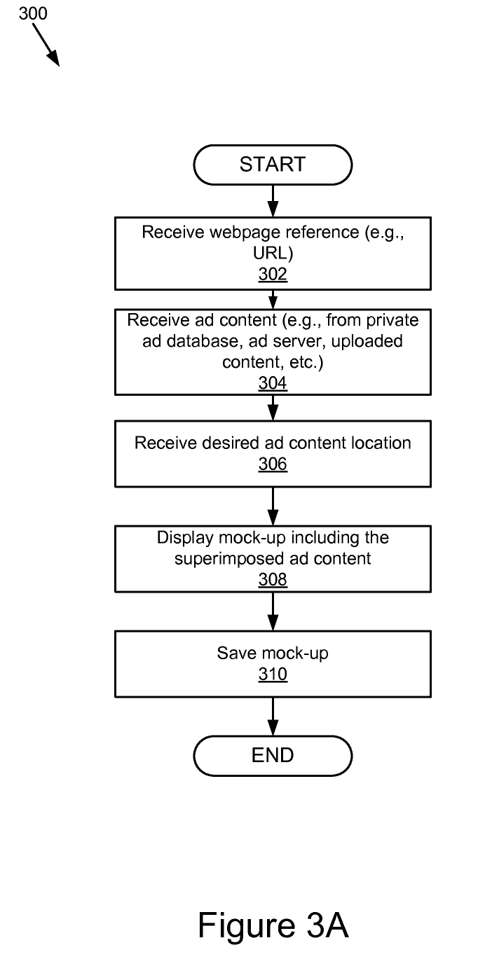

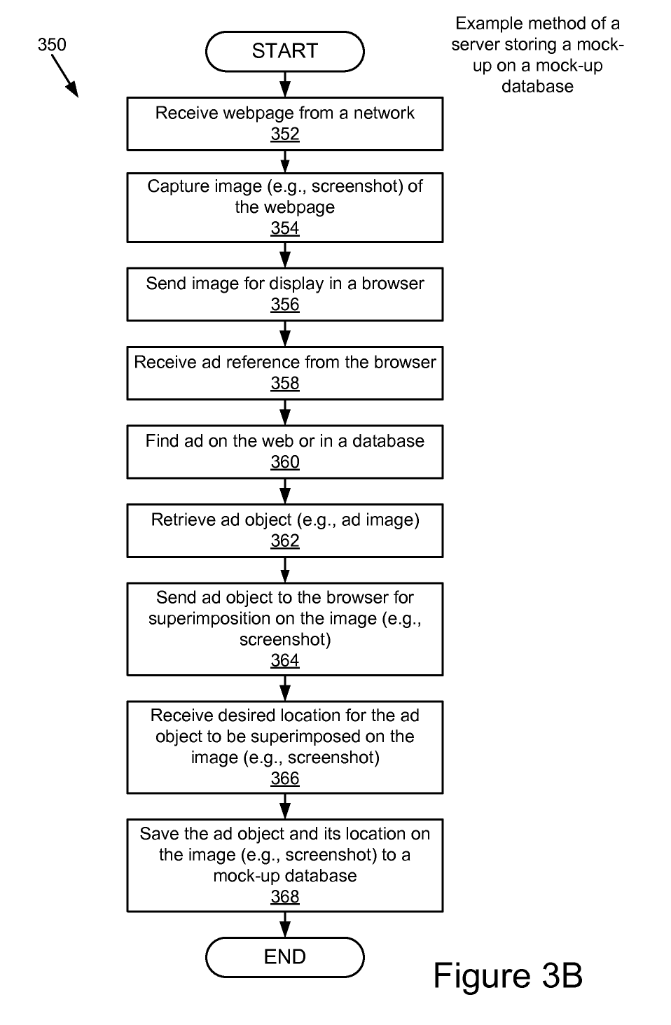

FIG. 3A is a flow chart illustrating an example method indicated by reference numeral 300 for generating and saving an advertisement mock-up. It should be understood that the order of the operations in FIG. 3 is merely by way of example and may be performed in different orders than those that are illustrated and some operations may be excluded, and different combinations of the operations may be performed. In the example method illustrated, one or more operations may include retrieving a webpage reference (e.g., URL), as illustrated by block 302. The method 300 then proceeds to the next block 304 and may include one or more operations to receive ad content (e.g., from private ad database, ad server, uploaded content, etc.). The method 300 then proceeds to the next block 306 and may include one or more operations to receive desired ad content location. The method 300 then proceeds to the next block 308 and may include one or more operations to display a “mock-up” including the superimposed ad content. The method 300 then proceeds to the next block 310 and may include one or more operations to save the “mock-up” as desired by the user, either for a temporary purpose or otherwise. It should be understood that the start and end designations in this flow chart are simply used to illustrate a start and end to a subroutine, routine, or program that accomplishes the functionality described.

FIG. 3B is an example method for storing a mock-up on a database, for example, one dedicated for storing mock-ups. It should be understood that the order of the operations illustrated in FIG. 3B is merely by way of example and that the order may be performed differently than that illustrated and some operations may be excluded and different combinations of the operations may be performed. The method 350 designated generally by reference numeral 350 begins and proceeds to block 352 including one or more operations for receiving webpages from a network. The method 350 proceeds to the next block 354 including one or more operations for capturing an image (e.g., a screenshot of the webpage). From that point, the method 350 proceeds to the next block 356, including one or more operations for sending an image for display in a browser 112 (one a client device 108(a-n). The method 350 proceeds to the next block 358, including one or more operations for receiving an ad reference from the browser 112. The method 350 proceeds to the next block 360 including one or more operations for finding an ad on the web or in a database. The method 350 proceeds to the next block 362 including one or more operations for retrieving an ad object (e.g., an ad image). The method 350 proceeds to the next block 364 including one or more operations for sending an ad object to the browser for superimposition on the image (e.g., a screenshot). The method 350 proceeds to the next block 366 including one or more operations for receiving desired locations for the ad object to be superimposed on the image (e.g., screenshot). The method 350 proceeds to the next block 368 including one or more operations for saving the ad object and its location on the image (e.g., screenshot) to a mock-up database. It should be understood that the start and end designations in this flow chart are simply used to illustrate a start and end to a subroutine, routine, or program that accomplishes the functionality described.

FIG. 4 is a detailed flow chart illustrating an example method indicated by reference numeral 400 for generating and saving an advertisement mock-up. It should be understood that the order of the operations illustrated in FIG. 4 is merely by way of example and that the method 400 may be performed in different orders than those that are illustrated and some operations may be excluded and different combinations of the operations may be performed. In the example method illustrated, the client device browser 112 (in FIG. 1) receives an input page reference, as illustrated by block 402. The method 400 then proceeds to the next block 410, where one or more servers (e.g., ad server 102, visualization and mock-up server 150, etc.) 1) may retrieve a webpage from the network 106, 2) may take or capture a screenshot of the webpage, and 3) may send or transmit the screenshot to the client device browser 112.

The method 400 then proceeds to the next block 404, which illustrates that the client device browser 112 receives the ad reference. The method 400 then proceeds to the next block 412, where one or more servers (as illustrated) may 1) find an ad on the web (e.g., network 106), 2) fetch the ad object (e.g., image) on an ad server database 420, and 3) deliver to the client device browser for superimposition.

The method 400 then proceeds to the next block 406, at which point the user may drag the ad to a desired spot or location in the page (e.g., screenshot). The method 400 then proceeds to the next block 408, at which the client device browser 112 saves the mock-up for later use. The method 400 then proceeds to the next block 414, where one or more servers save the webpage (i.e., screenshot) to a visualization and mock-up server database 440, either automatically or as designated by a user.

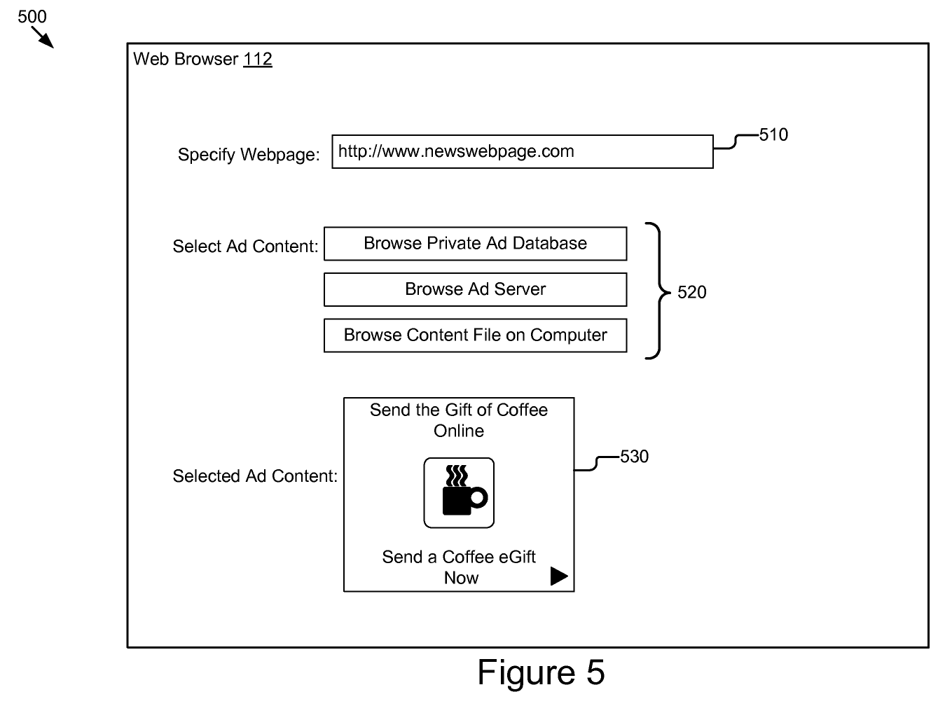

FIG. 5 illustrates a graphic representation of one example of a user interface 500 for specifying a webpage and selecting ad content. The user interface 500 includes a web browser 112 comprising a webpage address text box 510, ad content selection buttons, icon, or other visual displays 520, and a particular, selected, ad content image preview image 530. An example URL (e.g., provided by a user 110 via the client device 108) is illustrated in the web address box 510 to retrieve web content (e.g., a screenshot of the webpage) from the corresponding URL. The user may select ad content by selecting one of the content selection buttons 520 (e.g., browse private ad database, browse ad server, and browse content file on a computer). For example, the user may select ad content from a database of private or proprietary ads, a reference to an ad on the ad server 102, or a reference to an ad stored on the user's client device 108. The user interface 500 may then illustrate the selected ad content image preview image 530 corresponding to the ad selected using the content selection buttons 520 for the user 110 to view via a client device 108 to review and confirm that the desired ad content is properly selected.

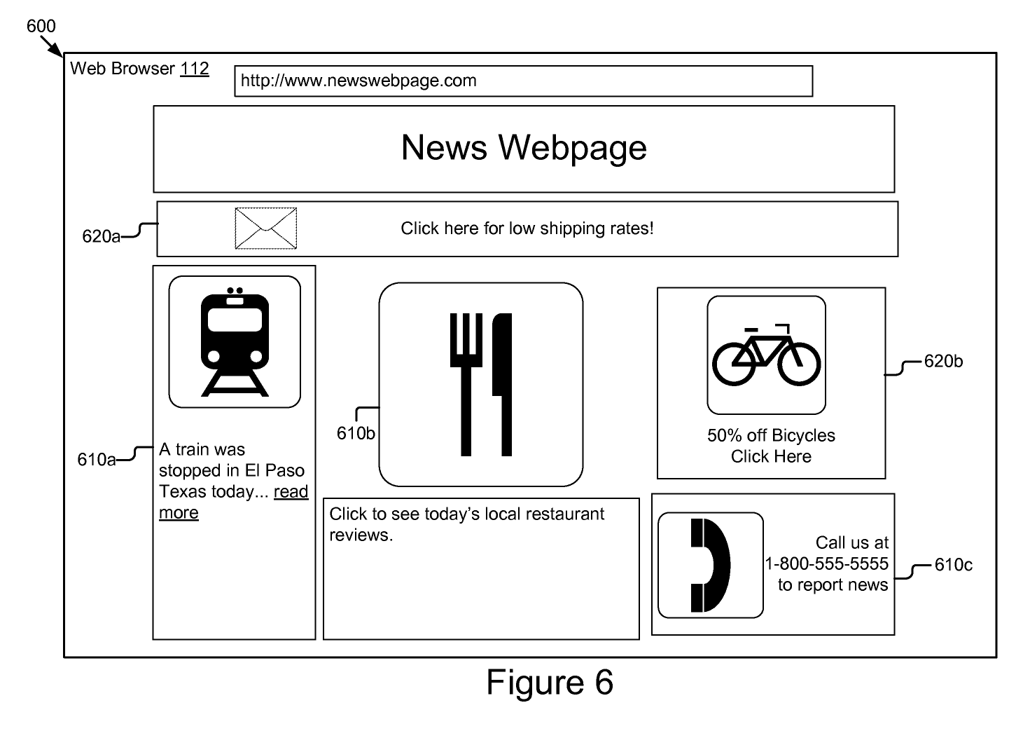

FIG. 6 illustrates a graphic representation of one example of a user interface 600 for displaying web content (e.g., a screenshot of a webpage). The user interface 600 includes a web browser 112 comprising web page content designated by reference numerals 610a, 610b, and 610c; and existing advertisement content 620a and 620b. For example, a user inputs a URL in the webpage address text box 510 (illustrated in FIG. 5) and the web browser 112 displays the web page corresponding to the received URL. In some embodiments, the web browser 112 displays an image (e.g., screenshot) of the webpage.

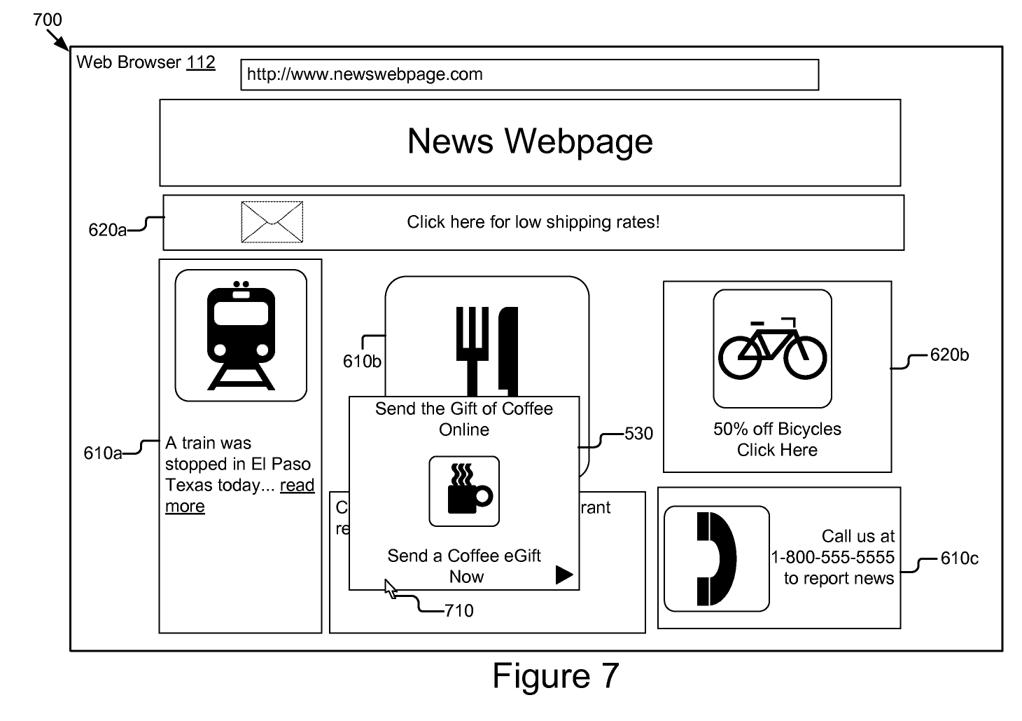

FIG. 7 shows a graphic representation of one example of a user interface 700 for displaying web content (e.g., a screenshot of a webpage) and a selected advertisement. The user interface 700 includes a web browser 112, comprising web page content designated by reference numerals 610a, 610b, and 610c; existing advertisement content 620a and 620b, a pointer 710, and a selected advertisement 530. For example, as illustrated, a user may input a URL in the webpage address text box 510 (illustrated in FIG. 5) and the web browser 112 automatically displays the web page corresponding to the received URL. In some embodiments, the web browser 112 displays an image (e.g., screenshot) of the webpage. In some embodiments, a user may select an advertisement (e.g., from private ad database, ad server, uploaded content, etc.) (as illustrated in FIG. 5) and the advertisement 530 is superimposed on the image (e.g., screenshot) of the webpage. In some embodiments, the user may “drag” the advertisement 530 to the desired location via the pointer 710.

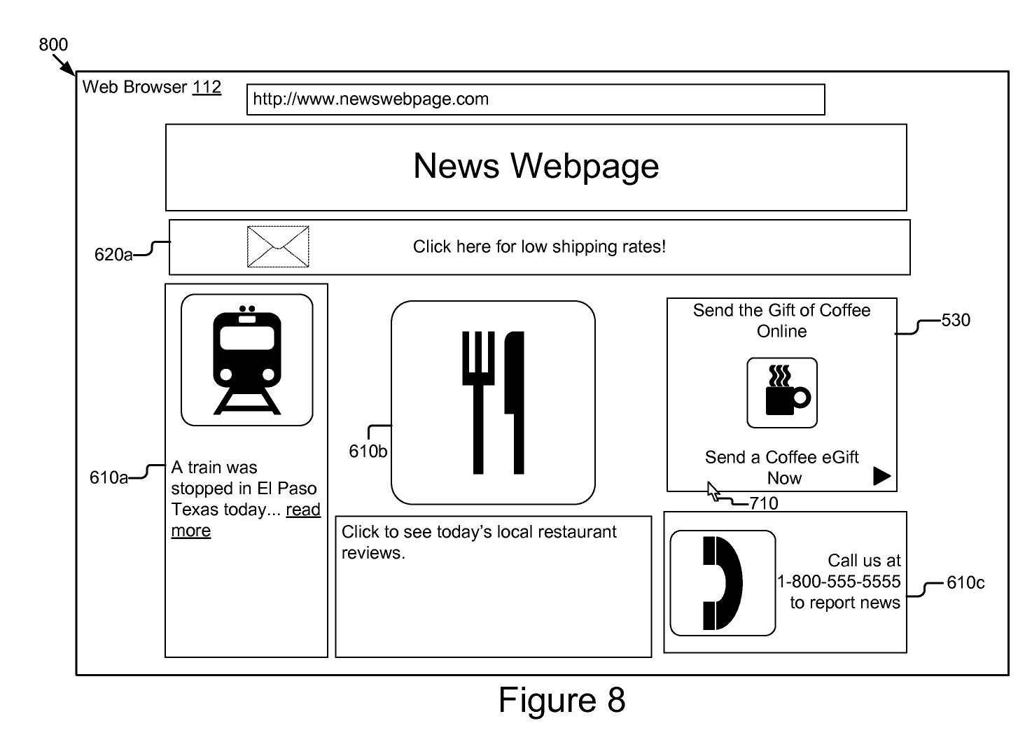

FIG. 8 shows a graphic representation of one example of a user interface 800 for displaying web content (e.g., a screenshot of a webpage) and a selected advertisement. The user interface 800 includes a web browser 112, comprising web page content designated by reference numerals 610a, 610b, and 610c; existing advertisement content 620a and 620b, a pointer 710, and a selected advertisement 530. For example, a user may input a URL in the webpage address text box 510 (illustrated in FIG. 5) and the web browser 112 automatically displays the web page corresponding to the received URL. In some embodiments, the web browser 112 displays an image (e.g., screenshot) of the webpage. In some embodiments, a user selects an advertisement (e.g., from private ad database, ad server, uploaded content, etc., as illustrated in FIG. 5) and the advertisement 530 is superimposed on the image (e.g., screenshot) of the webpage. In this example, the user has “dragged” the advertisement 530 to the desired location (over the existing advertisement content 620b) via the pointer 710.

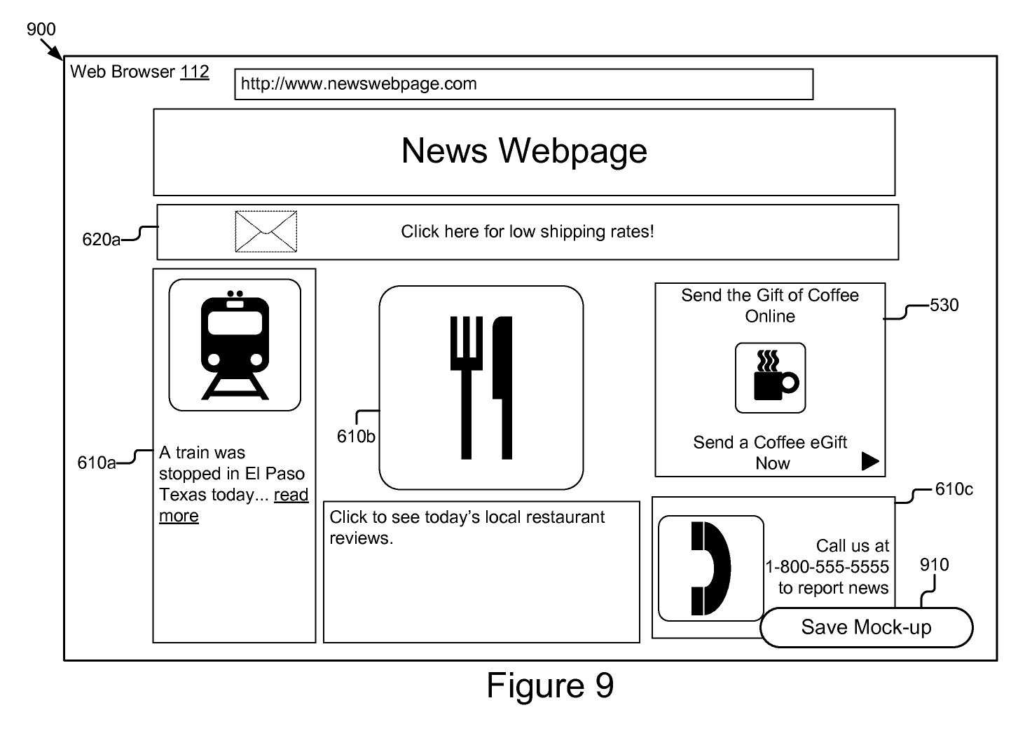

FIG. 9 shows a graphic representation of one example of a user interface 900 for displaying web content (e.g., a screenshot of a webpage) and a selected advertisement. The user interface 900 includes a web browser 112 comprising web page content 610a, 610b, and 610c; existing advertisement content 620a and 620b, a pointer 710, a selected advertisement 530, and a save mock-up button 910. For example, a user inputs a URL in the webpage address text box 510 (as illustrated in FIG. 5) and the web browser 112 displays the web page corresponding to the received URL. In some embodiments, the web browser 112 displays an image (e.g., screenshot) of the webpage. In some embodiments, a user selects an advertisement (e.g., from private ad database, ad server, uploaded content, etc., as illustrated in FIG. 5) and the advertisement 530 is superimposed on the image (e.g., screenshot) of the webpage. In this example, the user has “dragged” the advertisement 530 to the desired location (over the existing advertisement content 620b) via the pointer 710. Then the user may select the save mock-up button 910 and the information displayed in the web browser (e.g., screenshot of the webpage, advertisement 530, position of the advertisement 530, etc.) is stored in a database (e.g., the visualization and mock-up server database 440 (described in FIG. 4). In some embodiments, the user 110 may login to the mock-up tool at a later time and access the saved information (e.g., screenshot of the webpage, advertisement 530, position of the advertisement 530, etc.) and edit the saved data (e.g., change the location of the advertisement 530, change the advertisement 530, etc.).

It should be recognized that the foregoing description of the various embodiments of the present technology has been presented for the purposes of illustration and description. It is not intended to be exhaustive or to limit the present technology to the precise form disclosed. Many modifications and variations are possible in light of the above teaching. It is intended that the scope of the present technology be limited not by this detailed description, but rather by the claims of this application. As should be understood by those familiar with the art, the present technology may be embodied in other specific forms, without departing from the spirit or essential characteristics thereof. Likewise, the particular naming and division of the blocks, routines, features, attributes, methodologies, and other aspects are not mandatory or significant, and the mechanisms that implement the present disclosure or its features may have different names, divisions and/or formats. Furthermore, as should be apparent to one of ordinary skill in the relevant art, the blocks, routines, features, attributes, methodologies and other aspects of the present technology can be implemented as software, hardware, firmware, or any combination of the three. Also, wherever a component, an example of which is illustrated by a block, of the present technology is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present technology is in no way limited to implementation in any specific programming language, or for any specific operating system or environment. Accordingly, the disclosure of the present technology is intended to be illustrative, but not limiting, of the scope of the present disclosure, which is set forth in the following claims.

1. A computer-implemented method for displaying previews of content objects on webpages, the method comprising:
displaying, at a client device, an interactive preview interface including a plurality of input elements, each input element being configured to receive user input;
receiving, at the client device, first input corresponding to a web address, the first input being received at a first input element of the plurality of input elements included in the interactive preview interface;
in response to receiving the first input, accessing one or more web servers to retrieve web page data corresponding to a web page of the web address;
using the web page data to generate an image corresponding to a screenshot of the web page, the screenshot capturing at least a portion of the web page displayed on a computer device, and the screenshot including one or more defined content areas in which content is included;
receiving, at the client device, second input corresponding to a selection of a content object, the content object being an image for superimposing on the screenshot;
in response to receiving the second input:
retrieving the selected content object,
automatically scaling the content object; and
displaying, at the client device, each of the screenshot and the content object, the image of the content object being superimposed on the screenshot;
receiving, at the client device, third input corresponding to a drag-and-drop operation on the content object from a first location of the screenshot to a second location of the screenshot;
generating, at the client device, a preview image of the content object superimposed onto the screenshot, the content object being superimposed at the second location, and the second location corresponding to particular coordinates on the screenshot;
storing, at the client device, the preview image; and
displaying, at the client device, the preview image.

2. The computer-implemented method according to claim 1, wherein the interactive preview interface is stored in a database.

3. The computer-implemented method of claim 1, wherein the content object includes an image of one or more advertisements that are superimposed by drag-and-drop operation.

4. The computer-implemented method of claim 3, further comprising:
accommodating, using the one or more computing devices, the content object into an advertisement format.

5. The computer-implemented method of claim 1, further comprising:
receiving user log-in, by the one or more computing devices, into a server based application using the client device.

6. The computer-implemented method of claim 1, further comprising:
receiving, by the one or more computing devices, the content object from at least one from a group of a private database, an ad server, another application that collects and stores advertisements in a database, and the client device.

7. (canceled)

8. The method of claim 1, further comprising:
storing, by the one or more computing devices, the preview image on one or more servers.

9. A computer program product for displaying previews of content objects on webpages, comprising a non-transitory computer useable medium including a computer readable program, wherein the computer readable program when executed on a computer causes the computer to:
display, at a client device, an interactive preview interface including a plurality of input elements, each input element being configured to receive user input;
receive, at the client device, first input corresponding to one or more web addresses, the first input being received at a first input element of the plurality of input elements included in the interactive preview interface;
in response to receiving the first input, access one or more web servers to retrieve web page data corresponding to a web page of the web address;
use the web page data to generate an image corresponding to a screenshot of the web page, the screenshot capturing at least a portion of the web page displayed on a computer device, and the screenshot including one or more defined content areas in which content is included;
receive, at the client device, second input corresponding to a selection of a content object, the content object being an image for superimposing on the screenshot;
in response to receiving the second input:
retrieve the selected content object,
automatically scale the content object; and
display, at the client device, each of the screenshot and the content object, the image of the content object being superimposed on the screenshot;
receive, at the client device, third input corresponding to a drag-and-drop operation on the content object from a first location of the screenshot to a second location of the screenshot;
generate, at the client device, a preview image of the content object superimposed onto the screenshot, the content object being superimposed at the second location, and the second location corresponding to one or more coordinates on the screenshot;
store, at the client device, the preview image; and
display, at the client device, the preview image.

10. The computer program product according to claim 9, wherein the computer readable program when executed on a computer further causes the computer to store the preview image.

11. The computer program product according to claim 9, wherein the content object includes an image of one or more advertisements.

12. The computer program product according to claim 9, wherein the computer readable program when executed on a computer further causes the computer to:
accommodate the content object into an advertisement format.

13. The computer program product according to claim 9, wherein the computer readable program when executed on a computer further causes the computer to:
receive user log-in into a server-based application using the client device.

14. The computer program product according to claim 9, wherein the computer readable program when executed on a computer further causes the computer to:
receive the content object from at least one from a group of a private database, an ad server, another application that collects and stores advertisements in a database, and the client device.

15. (canceled)

16. A computer program product according to claim 9, wherein the computer readable program when executed on a computer further causes the computer to:
store the preview image on one or more servers.

17. A system for displaying previews of content objects on webpages, comprising:
a processor, and;
a memory storing instructions that, when executed, cause the system to:
display, at a client device, an interactive preview interface including a plurality of input elements, each input element being configured to receive user input;
receive, at the client device, first input corresponding to one or more web addresses, the first input being received at a first input element of the plurality of input elements included in the interactive preview interface;
in response to receiving the first input, access one or more web servers to retrieve web page data corresponding to a web page of the one or more web addresses;
use the web page data to generate an image corresponding to a screenshot of the web page, the screenshot capturing at least a portion of the web page displayed on a computer device, and the screenshot including one or more defined content areas in which content is included;
receive, at the client device, second input corresponding to a selection of a content object, the content object being an image for superimposing on the screenshot;
in response to receiving the second input:
retrieving the selected content object,
automatically scaling the content object; and
displaying, at the client device, each of the screenshot and the content object, the image of the content object being superimposed on the screenshot;
receive, at the client device, third input corresponding to a drag-and-drop operation on the content object from a first location of the screenshot to a second location of the screenshot;
generate, at the client device, a preview image of the content object superimposed onto the screenshot, the content object being superimposed at the second location, and the second location corresponding to particular coordinates on the screenshot;
store, at the client device, the preview image; and
display, at the client device, the preview image.

18. The system according to claim 17, wherein the content object includes an image of one or more advertisements that is scaled.

19. The system according to claim 17, wherein the memory further stores an instruction that causes the system to:
accommodate the content object into an advertisement format.

20. The system according to claim 17, wherein the memory further stores an instruction that causes the system to:
receive user log-in, into a server-based application using the client device.

21. The system according to claim 17, wherein the memory further stores an instruction that causes the system to:
receive the content object from at least one from a group of a private database, an ad server, another application that collects and stores advertisements in a database, and the client device.

22. (canceled)

23. The system according to claim 17, wherein the memory further stores an instruction that causes the system to:
store the preview image on one or more servers.
